(19) United States
(12) Patent Application Publication
(10) Pub. No.: US 2010/0066270 A1
(43) Pub. Date: Mar. 18, 2010

(54) Control method for maintaining the luminous intensity of a light-emitting diode light source

(75) Inventors: Tsung-Hsun Yang, Hsinchu (TW); Hung-Yu Chou, Taoyuan County (TW)

Correspondence Address: Juan Carlos A. Marquez;c/o Stites & Harbison PLLC, 1199 North Fairfax Street, Suite 900, Alexandria, VA, 22314-1437, US

(73) Assignee: National Central University

(21) Appl. No.: 12/292,265

(22) Filed: Nov. 14, 2008

(30) Foreign Application Priority Data
Sep. 12, 2008 (TW) 097135243

(51) Int. Cl. H05B 37/02

(52) U.S. Cl. 315/309

(57) ABSTRACT

The present invention provides a control method for maintaining the luminous intensity of an LED (Light-Emitting Diode) light source. The control method includes the steps of: providing a driving current source to drive the LED light source, monitoring and obtaining a first parameter of the LED light source, and comparing the first parameter with a second parameter. By monitoring the first parameter of the LED light source and combining the feedback mechanism, a driving current of the driving current source can be adjusted in real time to make the first parameter tend toward the second parameter. Thus, the luminous intensity of the LED light source can be maintained and will not be changed with the variation of the operating environment.

### BACKGROUND OF THE INVENTION

1. Technical Field

The present invention relates to a control method for maintaining luminous intensity of an LED (Light-Emitting Diode) light source. More particularly, the control method of the present invention implements a feedback mechanism to adjust a driving current of the LED light source in real time so as to maintain the luminous intensity of the LED light source.

2. Description of Related Art

With the rapid development of the photoelectric industry, the traditional light sources have tended to be replaced by light-emitting diode light sources. However, the existing LED light sources still need to be improved in luminous intensity, especially in the stability of luminous intensity, for meeting practical demands. After an LED light source works for a prolonged period of time, heat generated thereby can accumulate continuously and in turn cause increased junction temperature of the LED light source. With this thermal effect, light-emitting properties of the LED light source will change. For example, the luminous intensity of the LED light source will be lowered while light colors of the LED light source begin to shift.

In order to maintain the luminous intensity of LED light sources, driving devices adopting various optical sensors, temperature sensors, voltage sensors and so on have been developed to drive and monitor LED light sources in real time.

For instance, U.S. Pat. No. 7,132,805 teaches a technology that uses a temperature sensor, a current waveform sensor and a voltage differential sensor to monitor operational characteristics of an LED, such as operating temperature, operating current and so on of the LED, and adjust the input current in real time so as to stabilize the luminous intensity of the LED. However, since the LED light source driving device must incorporate various optical sensors, temperature sensors, voltage sensors and so forth, not only is the structural complexity of the driving device increased, but also the manufacturing cost of the driving device is raised, not to mention the complicated control method involved.

On the other hand, the LED driver circuit disclosed in U.S. Pat. No. 7,286,123 employs a control circuit to generate an LED current and monitor an LED voltage simultaneously, so as to adjust an LED current in reference to the LED voltage. Since the LED voltage is related to an LED temperature, it is feasible to adjust the LED current in accordance with the LED temperature.

Nevertheless, this LED driver circuit requires additional resistors to determine the LED current and a slope of adjustment of the LED current, and thus fails to reflect the real condition of the LED. Moreover, this LED driver circuit relies on a PWM circuit to control a switching frequency, a duty cycle, etc. of the LED current. That is, the LED current is periodically turned on/off. Consequently, the LED driver circuit is inadequate in monitoring the LED effectively in real time and maintaining the luminous intensity of the LED.

### SUMMARY OF THE INVENTION

In view of the problems of the prior art devices, the present invention provides a control method for maintaining luminous intensity of an LED light source. The method maintains the luminous intensity of the LED light source by directly monitoring a dynamic voltage drop or an equivalent junction temperature of the LED light source and adjusting a driving current of the LED light source accordingly.

In addition to maintaining the luminous intensity of the LED light source, another objective of the present invention is to reduce the need of additional sensors, such as optical sensors, temperature sensors and so on, so as to decrease the manufacturing cost of an LED light source driving device.

To achieve the aforementioned objectives of the present invention, the disclosed control method for maintaining the luminous intensity of an LED light source includes the steps of: providing a driving current source to drive the LED light source, monitoring and obtaining a first parameter of the LED light source, and comparing the first parameter with a second parameter and adjusting a driving current of the driving current source so as to make the first parameter tend toward the second parameter.

By practicing the present invention, at least the following effects can be achieved:

1. By monitoring a variation of the dynamic voltage drop or the equivalent junction temperature of the LED light source and adjusting the driving current of the LED light source accordingly, the luminous intensity of the LED light source can be controlled reliably and effectively.

2. By combining a feedback mechanism so as to adjust the driving current of the LED light source in real time, the luminous intensity of the LED light source can be controlled in real time.

3. By reducing the use of additional sensors, the LED light source driving device employing the disclosed control method can have a simplified structure and a lowered manufacturing cost.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawings, wherein:

FIG. 1 is a flowchart illustrating a control method for maintaining luminous intensity of an LED light source according to one embodiment of the present invention;

FIG. 2 is a schematic diagram of a control circuit performing the control method for maintaining the luminous intensity of the LED light source according to the embodiment of the present invention;

FIG. 3A provides one exemplificative adjustment of a driving current for the control method according to the present invention;

FIG. 3B provides another exemplificative adjustment of the driving current for the control method according to the present invention;

FIG. 4A graphically shows the relationship among driving current, voltage drop, junction temperature and light intensity of the LED light source in a target state; and

FIG. 4B graphically shows the relationship among driving current, voltage drop, junction temperature and light intensity of the LED light source during a process of reducing the driving current.

### DETAILED DESCRIPTION OF THE PREFERRED EMBODIMENTS

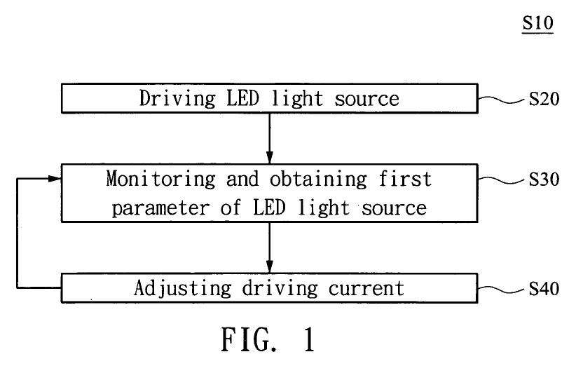

Referring to FIG. 1, in one embodiment of the present invention, a control method S10 for maintaining luminous intensity of an LED light source includes the steps of: driving the LED light source at a step S20; monitoring and obtaining a first parameter of the LED light source at a step S30; and adjusting a driving current at a step S40.

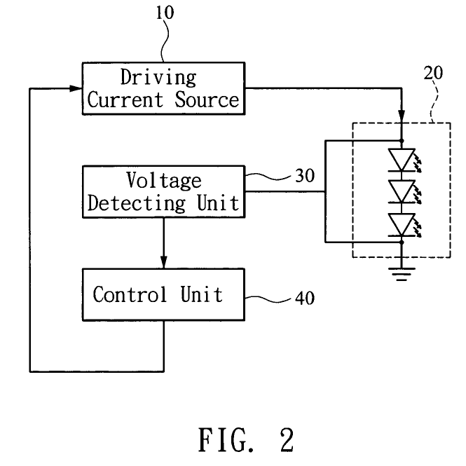

In the step S20 of driving the LED light source, referring to FIG. 2, the LED light source 20 is driven by a driving current source 10, which may be a direct current source, to emit light. The LED light source 20 may be a single light-emitting diode or a combination of a plurality of light-emitting diodes and may have an emission wavelength ranging between, but not limited to, 380 and 800 nm.

In the step S30 of monitoring and obtaining the first parameter of the LED light source, according to the present embodiment, the first parameter is defined as a dynamic voltage drop Vₜ or an equivalent junction temperature Tₜ. As shown in FIG. 2, the dynamic voltage drop Vₜ between two electrodes of the LED light source 20 can be monitored in real time by a voltage detecting unit 30. In addition, due to a linear relationship between the dynamic voltage drop Vₜ between the two electrodes of the LED light source 20 and the equivalent junction temperature Tₜ, it is possible to monitor the dynamic voltage drop Vₜ in real time and thereby detect variation of the equivalent junction temperature Tₜ in real time, and it is also possible to implement a control unit 40 for converting the dynamic voltage drop Vₜ detected by the voltage detecting unit 30 into the equivalent junction temperature Tₜ.

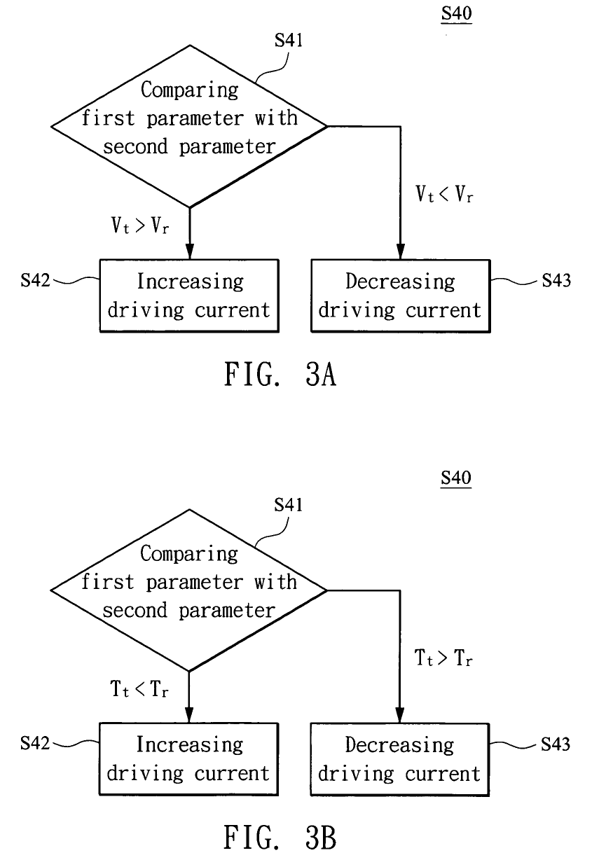

The step S40 of adjusting the driving current, as shown in FIGS. 3A and 3B, can be further divided into three sub-steps, which include: comparing the first parameter with a second parameter at a sub-step of S41; increasing the driving current at a sub-step of S42; and decreasing the driving current at a sub-step of S43.

Since the first parameter may be the dynamic voltage drop Vₜ or the equivalent junction temperature Tₜ, the second parameter, which is a target parameter at a target state, may be defined as a reference voltage drop Vᵣ or a reference junction temperature Tᵣ, accordingly. Therefore, the target state can be achieved only when the first parameter tends toward the second parameter.

In the sub-step S41 of comparing the first parameter with the second parameter, as can be seen in FIG. 2, when the first parameter is the dynamic voltage drop Vₜ and the second parameter is the reference voltage drop Vᵣ, the voltage detecting unit 30 detects the dynamic voltage drop Vₜ between the two electrodes of the LED light source 20, and the control unit 40 compares the dynamic voltage drop Vₜ with the reference voltage drop Vᵣ, wherein the reference voltage drop Vᵣ is a target voltage drop in the target state and may be preset in the control unit 40.

Furthermore, due to the linear relationship between the dynamic voltage drop Vₜ and the equivalent junction temperature Tₜ, it is possible to derive the equivalent junction temperature Tₜ in real time by corresponding to the dynamic voltage drop Vₜ, so that the control unit 40 compares the equivalent junction temperature Tₜ with the reference junction temperature Tᵣ, wherein the reference junction temperature Tᵣ is preset in the control unit 40.

In the sub-step S42 of increasing the driving current, referring to FIGS. 2 and 3A, when the first parameter is the dynamic voltage drop Vₜ, and more particularly, a forward voltage drop of the LED light source 20, if the dynamic voltage drop Vₜ is greater than the reference voltage drop Vᵣ(Vₜ>Vᵣ), it means that part of input electric power is converted into light energy and thereby increases the light intensity of the LED light source 20. Therefore, it is feasible to make the control unit 40 increase the driving current output by the driving current source 10 so as to decrease the dynamic voltage drop Vₜ of the LED light source 20 and make the dynamic voltage drop Vₜ tend toward the reference voltage drop Vᵣ, thereby drawing down the light intensity of the LED light source 20 toward the light intensity in the targeted stable state.

Reference is now made to FIGS. 2 and 3B. When the first parameter is the equivalent junction temperature Tₜ and the equivalent junction temperature Tₜ is smaller than the reference junction temperature Tᵣ(Tₜ<Tᵣ), it means that part of the input electric power is converted into light energy. Therefore, it is feasible to make the control unit 40 increase the driving current output by the driving current source 10 so as to increase the equivalent junction temperature Tₜ of the LED light source 20 and make the equivalent junction temperature Tₜ tend toward the reference junction temperature Tᵣ, thereby drawing down the light intensity of the LED light source 20 toward the light intensity in the targeted stable state.

In the sub-step S43 of decreasing the driving current, referring to FIGS. 2 and 3A, when the first parameter is the dynamic voltage drop Vₜ, and more particularly, a forward voltage drop of the LED light source 20, if the dynamic voltage drop Vₜ is smaller than the reference voltage drop Vᵣ(Vₜ<Vᵣ), it means that part of the input electric power is converted into thermal energy and thereby decreases the light intensity of the LED light source. Therefore, it is feasible to make the control unit 40 decrease the driving current output by the driving current source 10 so as to increase the dynamic voltage drop Vₜ of the LED light source 20 and make the dynamic voltage drop Vₜ tend toward the reference voltage drop Vᵣ, thereby drawing up the light intensity of the LED light source 20 toward the light intensity in the targeted stable state.

Then, as can be seen in FIGS. 2 and 3B, when the first parameter is the equivalent junction temperature Tₜ and the equivalent junction temperature Tₜ is greater than the reference junction temperature Tᵣ(Tₜ>Tᵣ), it means that part of the input electric power is converted into thermal energy. Therefore, it is feasible to make the control unit 40 decrease the driving current output by the driving current source 10 so as to decrease the equivalent junction temperature Tₜ of the LED light source 20 and make the equivalent junction temperature Tₜ tend toward the reference junction temperature Tᵣ, thereby drawing up the light intensity of the LED light source 20 toward the light intensity in the targeted stable state.

For further illustrating the present embodiment, exemplificative adjustments are described below, wherein the first parameter is the dynamic voltage drop Vₜ and the second parameter is the reference voltage drop Vᵣ.

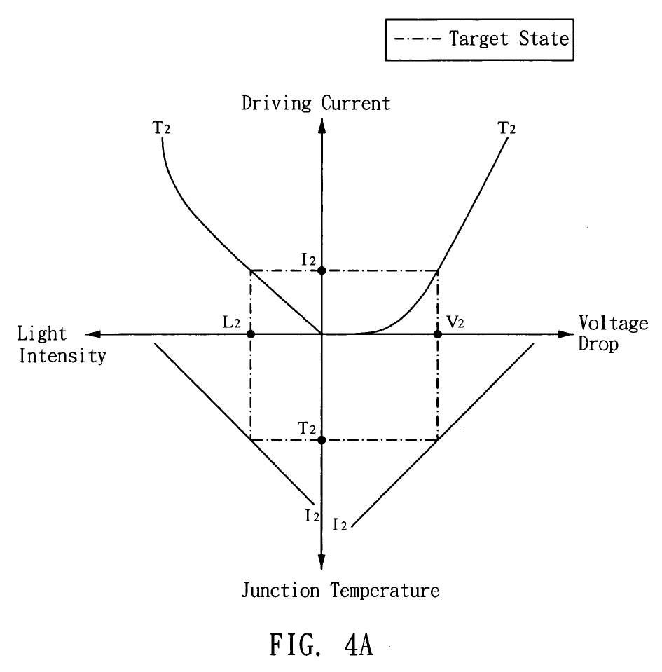

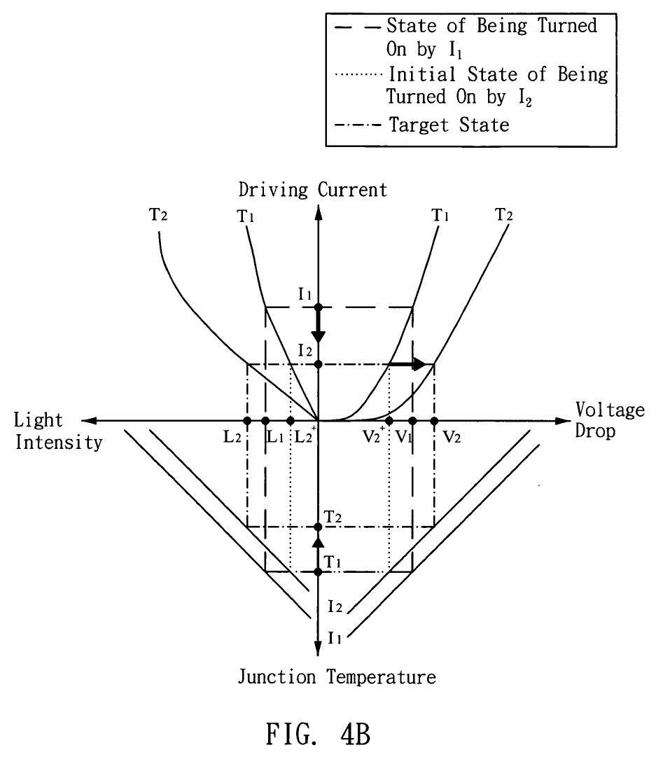

Seeing FIG. 4A, which graphically shows the relationship among driving current, voltage drop, junction temperature and light intensity of the LED light source 20 in the target state, when the target light intensity is L₂, it is learned from the plot that the target voltage drop corresponding thereto is V₂, and the target equivalent junction temperature is T₂. Thus, the target voltage drop V₂ can be set as the reference voltage drop Vᵣ and the target equivalent junction temperature is T₂ can be set as the reference junction temperature Tᵣ, wherein the reference voltage drop Vᵣ or the reference junction temperature Tᵣ can be preset in the control unit 40.

The luminous intensity of the LED light source 20 may change with variation of its operating environment. As shown in FIG. 4B, when the reference voltage drop Vᵣ is V₂ and the dynamic voltage drop Vₜ detected by the voltage detecting unit 30 is V₁, wherein the dynamic voltage drop Vₜ is smaller than the reference voltage drop Vᵣ, the driving current has to be decreased, for example, from a first driving current I₁ down to a second driving current I₂.

When the driving current is drawn from the first driving current I₁ down to the second driving current I₂, the equivalent junction temperature Tₜ of the LED light source 20 is not changed and remains at T₂ at the beginning, so that the dynamic voltage drop Vₜ corresponding to the equivalent junction temperature Tₜ is provisionally V₂⁺ while the light intensity is provisionally L₂⁺. Thus, the LED light source 20 is in an initial state where it is turned on by the second driving current I₂.

Then, after the LED light source 20 has been turned on by the second driving current I₂ for a period of time, the input electric power of the LED is reduced so that the part of the input electric power converted into thermal power is decreased. Consequently, the equivalent junction temperature Tₜ is lowered from T₁ to T₂, and the dynamic voltage drop Vₜ is drawn from V₂⁺ toward the reference voltage drop V₂ so that the light intensity of the LED light source 20 returns from L₂⁺ to L₂.

Thus, according to the present embodiment, it is feasible to control and change the driving current and in turn maintain the luminous intensity of the LED light source 20 by monitoring in real time the variation of the dynamic voltage drop Vₜ between the electrodes of the LED light source 20 and combining the feedback mechanism.

The present embodiment not only reduces the need of additional sensors so as to simplify the structure and reduce the manufacturing cost of the LED light source driving device, but also contributes to stable luminous intensity of the LED light source 20 by real-time control.

A particular embodiment has been described in detail for illustrating the features of the present invention so that one of ordinary skill in the art is enabled to understand and carry out the contents disclosed herein. However, it is understood that the embodiment is not intended to limit the scope of the present invention. Therefore, all equivalent changes or modifications which do not depart from the spirit of the present invention should be encompassed by the appended claims.

What is claimed is:

1. A control method for maintaining luminous intensity of an LED (Light-Emitting Diode) light source, comprising steps of:
providing a driving current source to drive the LED light source;
monitoring and obtaining a first parameter of the LED light source; and
comparing the first parameter with a second parameter and adjusting a driving current of the driving current source so as to make the first parameter tend toward the second parameter.

2. The control method of claim 1, wherein the LED light source is a single light-emitting diode or a combination of a plurality of light-emitting diodes.

3. The control method of claim 1, wherein the driving current source is a direct current source.

4. The control method of claim 1, wherein the step of comparing the first parameter with the second parameter is conducted by a control unit.

5. The control method of claim 4, wherein the second parameter is preset in the control unit.

6. The control method of claim 1, wherein the first parameter is a dynamic voltage drop and the second parameter is a reference voltage drop.

7. The control method of claim 6, wherein the dynamic voltage drop is derived by a voltage detecting unit.

8. The control method of claim 6, wherein the dynamic voltage drop is a forward voltage drop of the LED light source, and wherein the driving current is increased when the dynamic voltage drop is greater than the reference voltage drop, and the driving current is decreased when the dynamic voltage drop is smaller than the reference voltage drop.

9. The control method of claim 1, wherein the first parameter is an equivalent junction temperature and the second parameter is a reference junction temperature.

10. The control method of claim 9, wherein the equivalent junction temperature is derived in real time by corresponding to a dynamic voltage drop of the LED light source.

11. The control method of claim 9, wherein the driving current is decreased when the equivalent junction temperature is greater than the reference junction temperature, and the driving current is increased when the equivalent junction temperature is smaller than the reference junction temperature.
